(19) United States
(12) Patent Application Publication
(10) Pub. No.: US 2007/0007820 A1
(43) Pub. Date: Jan. 11, 2007

(54) Power supply capable of displaying power use condition of individual loads

(75) Inventors: Tsung-Chun Chen, Taipei Hsien (TW); Tsung-Te Lee, Taipei Hsien (TW)

Correspondence Address: BIRCH STEWART KOLASCH & BIRCH, PO BOX 747, FALLS CHURCH, VA, 22040-0747, US

(73) Assignee: Zippy Technology Corp.

(21) Appl. No.: 11/174,512

(22) Filed: Jul. 6, 2005

(51) Int. Cl. H02J 3/00

(52) U.S. Cl. 307/11

(57) ABSTRACT

A power supply capable of displaying power use conditions of individual loads includes a power detection element located on a power supply circuit between a second side rectification voltage stabilizing circuit on the circuit of a power supply and each DC output power supply of loads at the rear end. The power detection element generates electric alterations of the DC output power supply and is coupled to a power conversion unit via a connection line to generate a power detection value. The power detection value is output to a load power display unit which displays a power value corresponding to each DC output power supply in a use condition. One of the loads may be connected to a reference ground, and the power value of total DC output power supply in use conditions can be displayed.

### FIELD OF THE INVENTION

The present invention relates to a power supply capable of displaying power use conditions of individual loads and particularly to a switch power supply that can display power value of individual loads in use conditions.

### BACKGROUND OF THE INVENTION

Power supply is an indispensable basic equipment to provide electric power for computer system operation. How to make the power supply to provide stable electric power is a main focus in the industry at present. This is especially important in today's environment where the Internet and multimedia technologies advance rapidly. To enable the power supply to provide effective power requires constant user monitoring so that abrupt malfunction of the power supply caused by prolonged heavy loading or overloading can be prevented. And operation interruption or damage of computer systems caused by malfunction of the power supply can be avoided.

R.O.C. Patent Publication No. M258494 and No. M260779 disclose techniques that can display power use condition of loads. For instance, in M258494, a power supply is connected to a load display interface which is coupled to a power output end of a power supply through a linear rectification circuit to capture the total power of the power supply in a use condition. But for users who want to effectively control the existing power use condition of power supply, displaying the total power is not sufficient. And damage still might occur when heavy loads (such as CPU and graphic cards on the main board) are operating for a prolonged period of time or overloading occurs. In the event that one of DC outputs of the power supply is abnormal, the aforesaid techniques cannot provide a desired solution. Hence how to monitor individual DC output of the power supply is an issue pending to be resolved.

### SUMMARY OF THE INVENTION

The primary object of the present invention is to overcome the disadvantages mentioned above. The invention provides a technique to target power use condition of individual DC output power supply to enable users to have effective control according to power use value of the individual DC output power supply displayed on a load power display unit.

To achieve the foregoing object, the invention relies on a power detection element located on a power supply circuit between a second side rectification voltage stabilizing circuit on the circuit of a power supply and each DC output power supply of the loads at the rear end. The power detection element enables the DC output power supply to generate electric alterations and produce a power detection value through a power conversion unit coupled to a connection line. The power detection value is output to a load power display unit to display a power value in a use condition corresponding to the individual DC output power supply.

Another object of the invention is to display the total use power value of the power supply.

According to the invention, one of the loads is grounded for reference. The power supply circuit has the power detection element linking to the power conversion unit and the load power display unit to display the power value of the total DC output power supply in use conditions.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is a circuit block diagram of the present invention.

FIG. 2 is the circuit diagram of an embodiment of the present invention.

FIG. 3 is a circuit layout of the load power display unit and alarm circuit of the present invention.

### DETAILED DESCRIPTION OF THE PREFERRED EMBODIMENTS

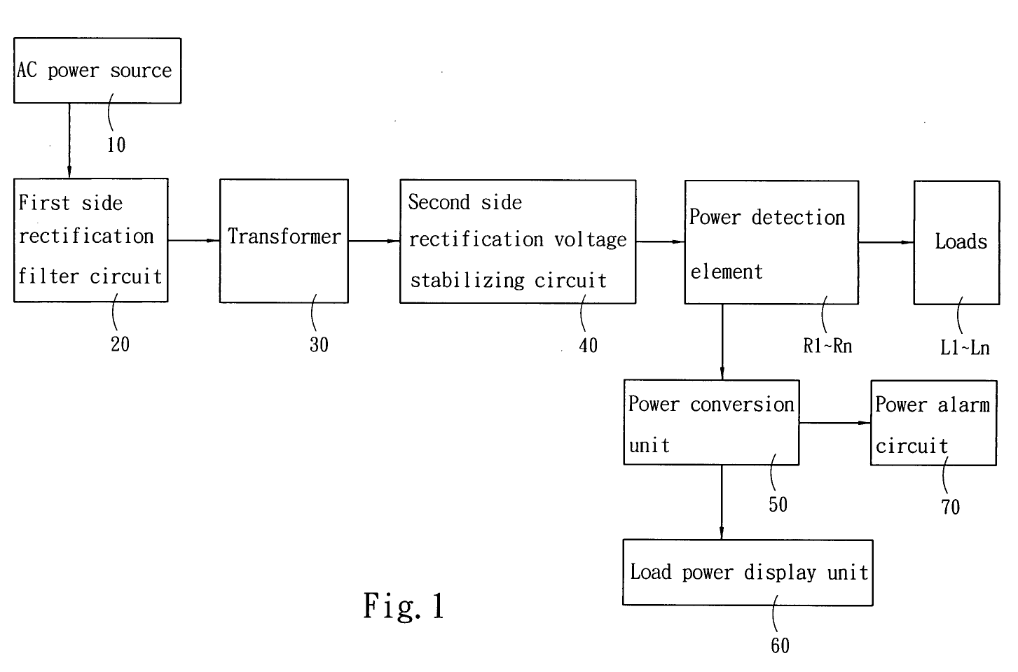

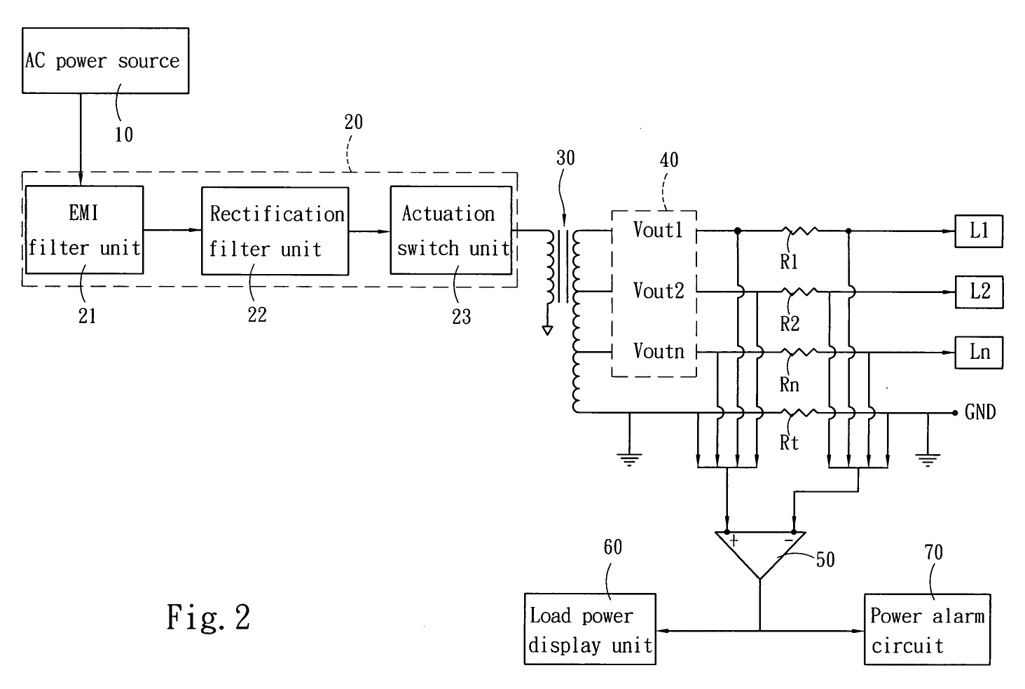

Please refer to FIGS. 1 and 2 for the circuit diagrams of an embodiment of the invention. The power supply capable of displaying power use condition of individual loads according to the invention includes sequentially a first side rectification filter circuit 20, a transformer circuit 30 and a second side rectification voltage stabilizing circuit 40 to transform and output multiple sets of DC output power supply to loads L1-Ln at a rear end. According to operation principle of the switch power supply based on the present technology, the first side rectification filter circuit 20 between an AC power source 10 and the transformer circuit 30 includes, in this order, an EMI filter unit 21, a rectification filter unit 22, and an actuation switch unit 23. The invention includes resistor power detection elements R1-Rn on the power supply circuit of the multiple sets of DC output power supply. The power detection elements R1-Rn are coupled to a power conversion unit 50 via a connection line to generate a power detection value. The power detection value is output to a load power display unit 60 to display a power value corresponding to each set of the DC output power supply in a use condition. Moreover, one set of the DC output power supply is linked to a reference ground GND. The power supply circuit thereof also has a power detection element Rt coupled to the power conversion unit 50. The load power display unit 60 also can display the power value of total DC output power supply in the use conditions. The load power display unit 60 may be, but not limited to, a LCD panel, a pointer display device or a cluster of LED lights or combination thereof. The power conversion unit 50 further is connected to a power alarm circuit 70 which may be a cluster of LED lights, or a buzzer to receive the power detection value and output an alarm signal to alert overload or heavy load condition of the loads L1-Ln.

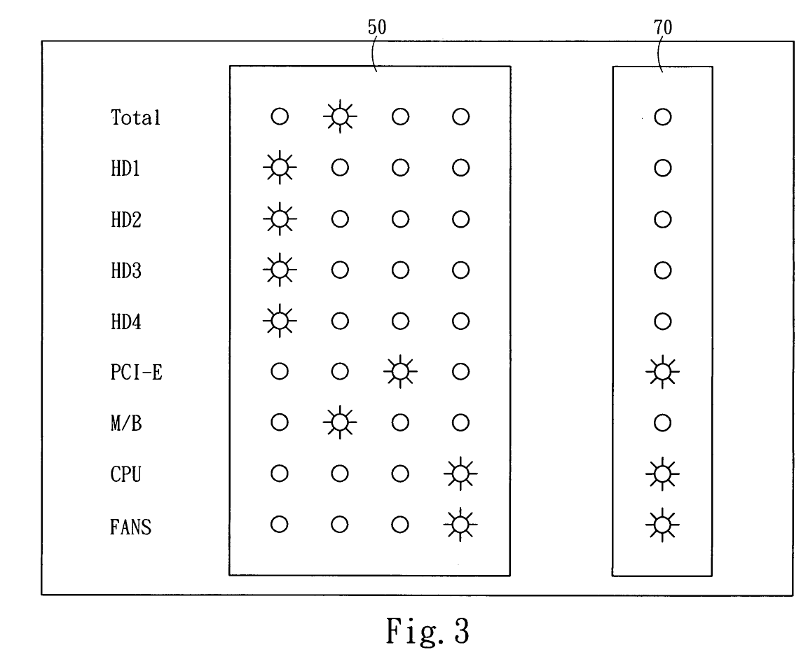

In this embodiment, AC is input from the power source 10 supplies AC through the EMI filter unit 21, rectification filter unit 22 and actuation switch unit 23 to boost the voltage and correct power factor, and enters through the first side of the transformer circuit 30 and outputs through the second side; then is transformed by the second side rectification voltage stabilizing circuit 40 to become multiple sets of DC output power supply at different voltages to be delivered to the loads L1-Ln at the rear end. Referring to FIG. 3, the loads L1-Ln may be electronic equipments such as hard disks (HD1-HD4), graphic card (PCI-E), main board (M/B), CPU, Fans, and the like. The invention provides multiple sets of power detection elements R1-Rn on the circuit between the second side rectification voltage stabilizing circuit 40 and the loads L1-Ln. Each of the power detection elements R1-Rn has a front end and a rear end connecting respectively to the +− input end of the power conversion unit 50. By means of the impedance characteristics of the power detection elements R1-Rn, when the DC output power passes through the power detection elements R1-Rn, a potential difference is generated to allow the individual loads L1-Ln that use the DC output power to generate power detection values. Based on the power detection values, the load power display unit 60 can display independently the power value of the individual loads L1-Ln in the use conditions. Hence users can monitor constantly. In the event that heavy loading or overloading occurs to the individual loads L1-Ln, the signal actuates the power alarm circuit 70 to generate an alarm signal to inform the users so that remedy actions may be taken immediately to prevent damages occurred to the loads L1-Ln caused by abnormal operation.

In addition, one of the loads L1-Ln is connected to a reference ground GND. The power supply circuit of the reference ground GND also has power detection elements R1-Rn. Hence the total power detection value of all DC output power supply can be detected. Similarly, through the load power display unit 60 and the power alarm circuit 70, the power condition can be monitored.

Referring to FIG. 3, even when the total power of all DC output power supply of the power supply is in a normal condition, some of the loads L1-Ln might be in a heavy loading or overloading condition. Hence apart from letting users to know the power use condition of the individual loads L1-Ln through the light indicators, the power alarm circuit 70 on one side can generate a blink light to alert users to take immediate actions (such as inspect connecting condition of the power cord, age condition of the power cord, or even change the power supply or the like). Thus by means of the invention, electric power use condition of all equipment of the computer system can be monitored and controlled constantly and individually. The risk of damage of the computer system resulting from electric power transmission can be minimized.

While the preferred embodiments of the invention have been set forth for the purpose of disclosure, modifications of the disclosed embodiments of the invention as well as other embodiments thereof may occur to those skilled in the art. Accordingly, the appended claims are intended to cover all embodiments which do not depart from the spirit and scope of the invention.

What is claimed is:

1. A power supply capable of displaying power use conditions of individual loads, comprising sequentially a first side rectification filter circuit, a transformer and a second side rectification voltage stabilizing circuit to transform and output multiple sets of DC output power supply to loads at a rear end, wherein:
the multiple sets of DC output power supply have a power supply circuit which has a power detection element linking to a power conversion unit via a connection line to generate a power detection value which is output to a load power display unit to display a power value corresponding to each DC output power supply in a use condition.

2. The power supply of claim 1, wherein one of the DC output power supply is connected to a reference ground, the power supply circuit having another power detection element connecting to the power conversion unit, the load power display unit displaying another power value corresponding to total DC output power supply in use conditions.

3. The power supply of claim 1, wherein the power supply is a switch power supply.

4. The power supply of claim 1, wherein the first side rectification filter circuit and the transformer are bridged sequentially by an EMI filter unit, a rectification filter unit and an actuation switch unit.

5. The power supply of claim 1, wherein the load power display unit is a liquid crystal display panel.

6. The power supply of claim 1, wherein the load power display unit is a pointer display device.

7. The power supply of claim 1, wherein the load power display unit is a cluster of LED lights.

8. The power supply of claim 1, wherein the power conversion unit is coupled with a power alarm circuit to receive the power detection value to output an alarm signal to alert an overloading and heavy loading condition of the loads.

9. The power supply of claim 8, wherein the power alarm circuit is a cluster of LED lights.

10. The power supply of claim 8, wherein the power alarm circuit is a buzzer.

11. The power supply of claim 1, wherein the power detection element is a resistor.

12. A power supply capable of displaying power use conditions of individual loads, comprising a first side rectification filter circuit, a transformer and a second side rectification voltage stabilizing circuit to transform and output multiple sets of DC output power supply to loads at a rear end, wherein:
one of sets the DC output power supply is connected to a reference ground and has a power supply circuit which has a power detection element linking to a power conversion unit via a connection line to generate a power detection value which is output to a load power display unit to display a power value corresponding to total DC output power supply in use conditions.

13. The power supply of claim 12, wherein the first side rectification filter circuit and the transformer are bridged sequentially by an EMI filter unit, a rectification filter unit and an actuation switch unit.

14. The power supply of claim 12, wherein the load power display unit is a liquid crystal display panel.

15. The power supply of claim 12, wherein the load power display unit is a pointer display device.

16. The power supply of claim 12, wherein the load power display unit is a cluster of LED lights.

17. The power supply of claim 12, wherein the power conversion unit is coupled with a power alarm circuit to receive the power detection value to output an alarm signal to alert overloading and heavy loading condition of the loads.

18. The power supply of claim 17, wherein the power alarm circuit is a cluster of LED lights.

19. The power supply of claim 17, wherein the power alarm circuit is a buzzer.

20. The power supply of claim 12, wherein the power detection element is a resistor.
